(19) United States
(12) Patent Application Publication
(10) Pub. No.: US 2014/0213401 A1
(43) Pub. Date: Jul. 31, 2014

(54) CHAIN GUIDE

(71) Applicant: TSUBAKIMOTO CHAIN CO., Osaka (JP)

(72) Inventors: Masahiko Konno, Osaka-shi (JP); Kaori Mori, Osaka-shi (JP); Yuichiro Ishikawa, Osaka-shi (JP); Yudai Takagi, Osaka-shi (JP)

(73) Assignee: TSUBAKIMOTO CHAIN CO., Osaka (JP)

(21) Appl. No.: 14/147,979

(22) Filed: Jan. 6, 2014

(30) Foreign Application Priority Data
Jan. 28, 2013 (JP) 2013-013432

(51) Int. Cl. F16H 7/18

(52) U.S. Cl. CPC F16H 7/18
USPC 474/140

(57) ABSTRACT

By employing a simple configuration, a space required for engine room can be minimized while securing enough strength, rigidity, and durability, and a reduction in a material waste, manufacturing processes, and manufacturing cost can be accomplished while occurrence of a crack or breakage during use is prevented. A chain guide includes a guide shoe, a base member configured to reinforce the guide shoe, and attaching sections. The base member is formed by a bar made of a metal material.

### BACKGROUND OF THE INVENTION

1. Field of the Invention

The present invention relates to a chain guide including a guide shoe configured to slide and guide a traveling chain, a base member configured to reinforce the guide shoe along a chain traveling direction, and at least one attaching section.

2. Description of the Related Art

In order to stabilize a chain traveling between sprockets and properly retain tension, a chain guide including a guide shoe configured to slide and guide the traveling chain has been used in common.

For example, a timing system for an engine is publicly known that drives a driving chain CH such as a roller chain endlessly wound between sprockets S1 and S2 respectively provided in a crank shaft and a cam shaft in an engine room as shown in FIG. 23. The timing chain CH is endlessly wound between a driving sprocket S1 attached to the crank shaft and a pair of driven sprockets S2 attached to the cam shaft in the engine room E. The timing chain CH is guided by a chain guide 600 (a swinging guide) and a chain guide 500 (a fixed guide).

In the publicly-known timing system, the chain guide 500 (the fixed guide) is fixed in the engine room E by two attachment shafts B1 and B2. The chain guide 600 (the swinging guide) is attached in the engine room E to be capable of swinging in a winding plane of the timing chain CH around a swinging shaft B0.

A chain tensioner T presses the chain guide 600 (the swinging guide) to properly retain the tension of the timing chain CH and suppress vibration of the timing chain CH.

In a chain guide used in such a publicly-known timing system, a traveling guide section is desirably formed of a low-friction material resistive to wear. A chain guide entirely formed of a low-friction resin material is publicly known.

However, the chain guide requires certain degrees of strength, rigidity, and durability in order to stably guide a chain against the tension and the vibration of the chain. When the chain guide is formed of only a resin material, in order to obtain the necessary strength, rigidity, and the durability, the thickness of the material need to be increased. Therefore, the chain guide occupies a large space in an engine room.

Therefore, a chain guide is publicly known in which a traveling guide section is formed of a low-friction resin material and the other portions are formed of a material having large strength, rigidity, and durability such as metal to support the resin material to thereby reduce a space occupied by the chain guide while securing strength, rigidity, and durability necessary for the entire chain guide (see Japanese Patent Application Laid-Open No. H10-89428.)

For example, the chain guide 500 (a fixed guide) publicly known in Japanese Patent Application Laid-Open No. H10-89428 includes, as shown in FIG. 24 to FIGS. 26A to 26C, a guide shoe 510 made of resin configured to slide and guide a traveling chain and a base member 520 made of tabular metal configured to reinforce the guide shoe 510 along a chain traveling direction.

The base member 520 includes a shoe supporting section 521 extending in the chain traveling direction and attaching sections 522 respectively extending vertically in positions spaced apart from each other in the chain traveling direction. The base member 520 is formed by bending an integral metal plate at 90° in two places to form the attaching sections 522 to be perpendicular to the shoe supporting section 521.

Attachment holes 523, through which bolts or the like are inserted, are respectively provided in the attaching sections 522 in the two places.

The guide shoe 510 is configured to be capable of being fitted with and unfitted from the base member 520 when a traveling guide section 511 is supported and reinforced by the shoe supporting section 521 of the base member 520 and end locking pieces 512 at both ends in the chain traveling direction and a plurality of side locking pieces 513 provided in appropriate portions in the width direction are locked to the shoe supporting section 521.

In such a publicly-known chain guide, the base member 520 needs to be formed by punching a thick metal plate in order to increase the strength, the rigidity, and the durability of the base member 520. Therefore, a large machining machine is necessary and machining costs increase.

When the base member 520 is formed by punching the metal plate, a burr remains on a cutting surface of the metal plate. The burr comes into contact with the guide shoe 510 and gives a very small scratch to the guide shoe 510. The scratch becomes a stress concentration point to cause breakage.

Further, the base member 520 is formed by bending the integral metal plate at 90° in the two places to form the shoe supporting section 521 and the attaching sections 522 in the two places. Therefore, bending for the two places is necessary and manufacturing man-hour increases.

A large amount of metal material is necessary because the shoe supporting section 521 and the attaching sections 522 in the two places are formed of the integral metal plate. When the shoe supporting section 521 and the attaching sections 522 are manufactured from one metal plate by punching or the like, since the shoe supporting section 521 and the attaching sections 522 are formed in a shape profile having large number of projecting sections, a waste of the material increases.

### SUMMARY OF THE INVENTION

The present invention solves the problems by forming, in a chain guide, the strength, the rigidity, and the durability of which are improved by a base member, the base member from a bar made of a metal material rather than forming the base member by punching a metal plate. It is an object of the present invention to provide a chain guide capable of reducing an occupied space in an engine room while maintaining necessary strength, rigidity, and durability with a simple configuration, reducing manufacturing man-hour and a waste of a material, reducing manufacturing costs, and preventing breakage during use.

The present invention provides a chain guide including: a guide shoe configured to slide and guide a traveling chain; a base member configured to reinforce the guide shoe along a chain traveling direction; and at least one attaching section. The base member is formed by a bar made of a metal material. Consequently, the present invention solves the problems.

With the chain guide according to claim 1, it is possible to reduce an occupied space by forming the base member contributing to strength, rigidity, and durability from a material different from the material of the guide shoe. Since the base member is formed by the bar made of the metal material, it is possible to easily manufacture the base member with a simple method of, for example, cutting a long bar at appropriate length. Therefore, a manufacturing process is simplified.

It is possible to arbitrarily design a sectional shape of the bar. It is possible to secure necessary strength, rigidity, and durability with a small amount of material. A waste of the material, which occurs in the punching or the like, does not occur. Therefore, it is possible to reduce manufacturing costs.

Further, on the surface in the longitudinal direction of the bar, a burr or the like due to cutting, punching, or the like is absent. Therefore, a contact surface of the guide shoe is not scratched by the burr or the like. It is possible to prevent occurrence of a crack and breakage caused by scratches during use.

With a configuration described in claim 2, it is possible to reduce the friction of a traveling guide section and molding is facilitated in injection molding or the like by forming the guide shoe from a synthetic resin material. Further, it is possible to sufficiently secure strength, rigidity, and durability with a less material while reducing an occupied space by forming the base member from a steel bar subjected to pultrusion molding.

It is possible to easily machine the steel bar subjected to the pultrusion molding into an arbitrary cross section. It is possible to reduce manufacturing costs. Further, since the surface in the longitudinal direction of the bar is smoothed, it is possible to more surely prevent breakage during use.

With a configuration described in claim 3, it is possible to form the attaching sections by bending the base member. Therefore, manufacturing is facilitated.

With a configuration described in claim 4, the attaching sections can be formed integrally with the guide shoe by injection molding or the like. Therefore, manufacturing is facilitated.

With a configuration described in claim 5, the attaching section formed by bending the base member and the attaching section formed integrally with the guide shoe are mixed. Therefore, it is possible arbitrarily set a space of a plurality of the attaching sections by changing a positional relation in the longitudinal direction between the guide shoe and the base member, it is possible to easily absorb an error in dimensions between the attaching sections and a part to which an engine or the like is fixed, and attachment work is facilitated.

When the base member and the guide shoe expand or contract because of a temperature change or are deformed by a tension change, vibration, or the like of the chain during use, it is possible to allow a force applied in the chain traveling direction to escape by relatively displacing the base member and the guide shoe. Since concentrated stress is not applied to a specific part, it is possible to further improve durability.

Further, since concentrated stress is not applied to all the attaching sections, it is possible to surely prevent the fixing from being loosened, prevent an increase in vibration and noise during use, and reduce a maintenance work load.

With a configuration described in claim 6, the base member is integrated with the guide shoe by, for example, molding during manufacturing of the guide shoe. Therefore, it is possible to omit an assembly process and reduce manufacturing costs.

With a configuration described in claim 7, the base member is configured to be detachably attachable to the guide shoe. Therefore, it is possible to individually design the base member and the guide shoe and it is possible to cope with different specifications by combining the base member and the guide shoe as appropriate. As a result, versatility is improved.

With a configuration described in claim 8, the base member is formed in a pipe shape having a hollow on the inside. Therefore, it is possible to sufficiently secure strength, rigidity, and durability with a less material.

With a configuration described in claim 9, a plurality of the base members are provided in parallel. Therefore, it is possible to secure necessary strength, rigidity, and durability by changing the number of the same bars even if requested specifications are different. As a result, versatility is further improved.

With a configuration described in claim 10, at least a portion of the base member is machined into a sectional shape different from the sectional shape of the other portions. Therefore, different sectional shape portions can act as locking sections and regulate relative movements of the base member and the guide shoe. It is possible to prevent an increase in vibration and sound during use, breakage, and the like.

### BRIEF DESCRIPTION OF THE DRAWINGS

FIG. 1 is a top perspective view of a chain guide according to a first embodiment of the present invention;

FIG. 2 is a bottom perspective view of the chain guide according to the first embodiment of the present invention;

FIGS. 3A to 3C are respectively a plan view, a front view, and a bottom view of the chain guide according to the first embodiment of the present invention;

FIGS. 4A and 4B are respectively a side view and an A-A sectional view of the chain guide according to the first embodiment of the present invention;

FIGS. 5A and 5B are respectively a side view and an A-A sectional view of a modification in which a plurality of base members in the first embodiment of the present invention are provided;

FIGS. 6A to 6P are explanatory diagrams of other modifications of the shape and the arrangement of the base member in the first embodiment of the present invention; FIG. 7 is a top perspective view of a chain guide according to a second embodiment of the present invention;

FIG. 8 is a bottom perspective view of the chain guide according to the second embodiment of the present invention;

FIGS. 9A to 9C are respectively a plan view, a front view, and a bottom view of the chain guide according to the second embodiment of the present invention;

FIGS. 10A and 10B are respectively a side view and a B-B sectional view of the chain guide according to the second embodiment of the present invention;

FIG. 11 is a top perspective view of a chain guide according to a modification of attaching sections of a base member in the second embodiment of the present invention;

FIG. 12 is a top perspective view of a chain guide according to another modification of the attaching sections of the base member in the second embodiment of the present invention;

FIG. 13 is a top perspective view of a chain guide according to still another modification of the attaching sections of the base member in the second embodiment of the present invention;

FIGS. 14A to 14D are explanatory diagrams of chain guides according to modifications of the base member in the second embodiment of the present invention;

FIG. 15 is a top perspective view of a chain guide according to a third embodiment of the present invention; FIG. 16 is a bottom perspective view of the chain guide according to the third embodiment of the present invention;

FIGS. 17A to 17C are respectively a plan view, a front view, and a bottom view of the chain guide according to the third embodiment of the present invention;

FIGS. 18A and 18B are respectively a side view and a C-C sectional view of the chain guide according to the third embodiment of the present invention;

FIG. 19 is a top perspective view of a chain guide according to a fourth embodiment of the present invention;

FIG. 20 is a bottom perspective view of the chain guide according to the fourth embodiment of the present invention;

FIGS. 21A to 21C are respectively a plan view, a front view, and a bottom view of the chain guide according to the fourth embodiment of the present invention;

FIGS. 22A and 22B are respectively a D-D side view and an E-E sectional view of the chain guide according to the fourth embodiment of the present invention;

FIG. 23 is an explanatory diagram of a timing system of a conventional engine;

FIG. 24 is a top perspective view of a conventional chain guide;

FIG. 25 is a bottom perspective view of the conventional chain guide; and

FIGS. 26A to 26C are respectively a plan view, a front view, and a bottom view of the conventional chain guide.

### DESCRIPTION OF THE PREFERRED EMBODIMENT

The present invention is based on the technical idea that, in a chain guide, the strength, the rigidity, and the durability of which are improved by a base member, the base member is formed of a bar made of a metal material rather than being formed by punching a metal plate. The chain guide includes a guide shoe configured to slide and guide a traveling chain, a base member configured to reinforce the guide shoe along a chain traveling direction, and at least one attaching section. The base member is formed by a bar made of a metal material. The specific configuration of the chain guide may be any configuration as long as the chain guide is capable of reducing an occupied space in an engine room while maintaining necessary strength, rigidity, and durability with a simple configuration, reducing manufacturing man-hour and a waste of a material, reducing manufacturing costs, and preventing breakage during use.

As the base member, a publicly-known appropriate metal material only has to be selected according to conditions such as rigidity, durability, moldability, and costs. A steel bar subjected to pultrusion molding is suitable.

As the material of the guide shoe, a publicly-known appropriate material only has to be selected according to conditions such as frictional resistance, rigidity, durability, moldability, and costs. In particular, a synthetic resin material is suitable.

### First Embodiment

A chain guide 100 (a fixed guide) according to a first embodiment of the present invention is explained based on the drawings.

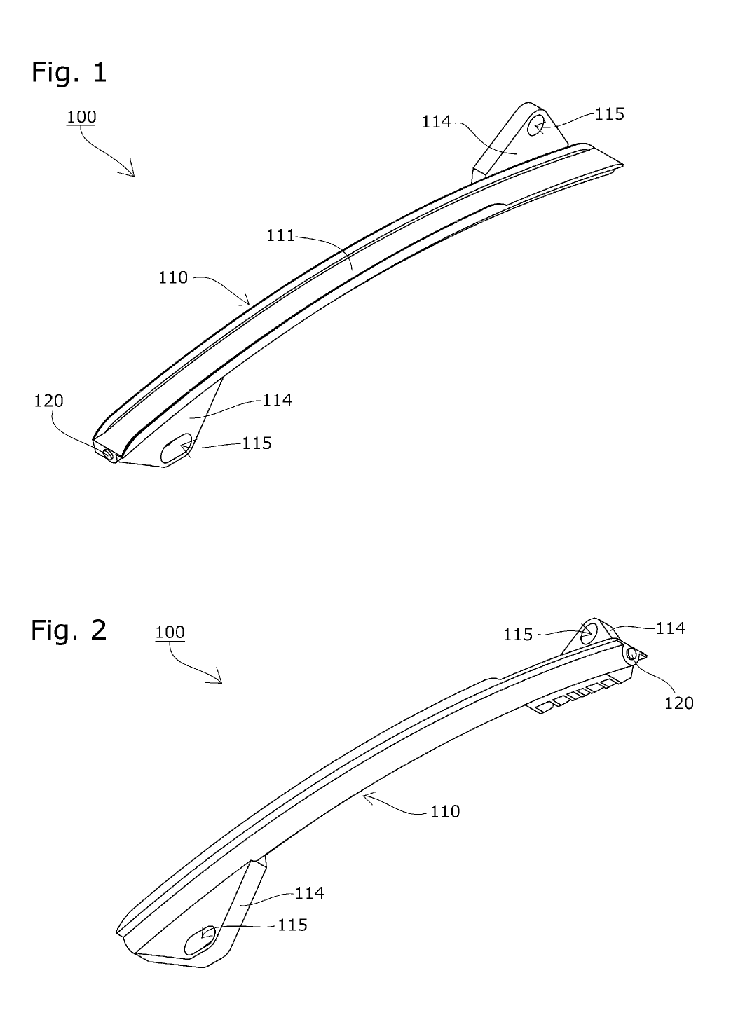

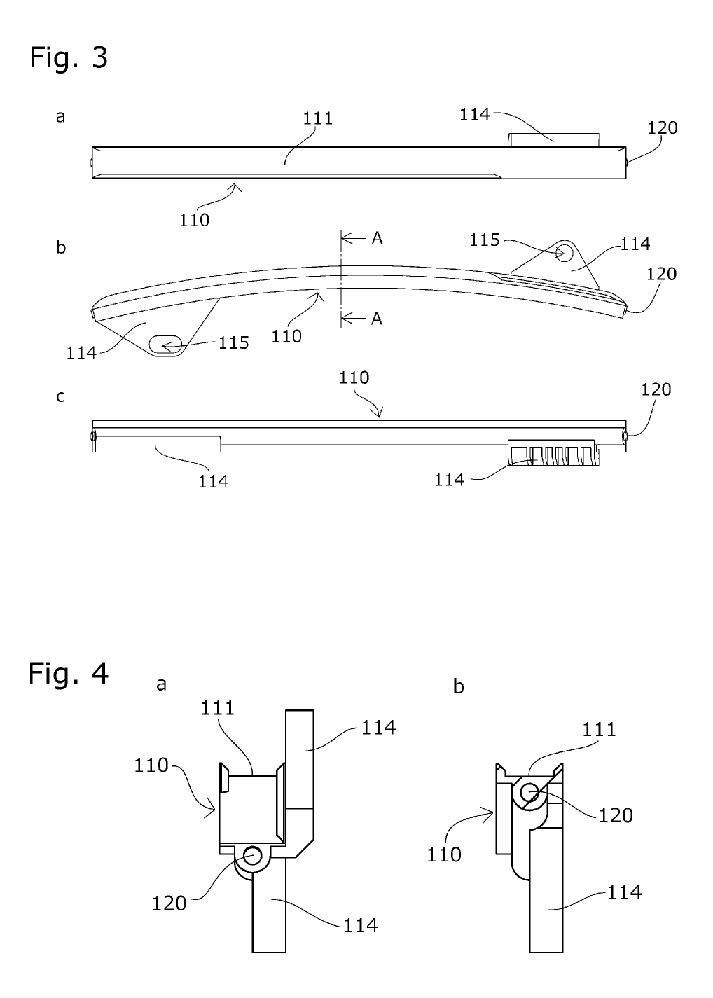

The chain guide 100 is applied to the publicly-known timing system explained above. As shown in FIG. 1 to FIGS. 4A and 4B, the chain guide 100 includes a guide shoe 110 configured to slide and guide a traveling chain and a base member 120 configured to reinforce the guide shoe 110 along a chain traveling direction and improve strength, rigidity, and durability.

The base member 120 is formed of a bar of metal extending in the chain traveling direction. The base member 120 is formed by, for example, drawing a steel material and cutting the steel material at appropriate length.

The base member 120 is given a predetermined bending shape along the chain traveling direction.

The guide shoe 110 includes a traveling guide section 111 extending in the chain traveling direction. The guide shoe 110 is formed of a synthetic resin material and integrally molded by, for example, injection molding in a state in which the base member 120 is inserted into the guide shoe 110.

Attaching sections 114 are formed to extend to a front surface side on an upstream side and to a rear surface side on a downstream side in the chain traveling direction. In the attaching sections 114, attachment holes 115, through which bolts or the like for fixing the attaching sections 114 in an engine room are inserted, are respectively provided. The attaching sections 114 are reinforced by ribs in order to secure strength and rigidity according to necessity.

One of the attachment holes 115 (in this embodiment, the attachment hole 115 on the downstream side) is formed as a long hole such that an error in dimensions between the attachment hole 115 and a part to which an engine or the like is fixed and a difference in expansion and contraction between the attachment hole 115 and the part to which the engine or the like is fixed due to a temperature change can be absorbed.

Note that, in this embodiment, the right direction in FIG. 1 to FIGS. 3A to 3C is the upstream side in the chain traveling direction. The left direction in the figures is the downstream side in the chain traveling direction. A chain traveling surface side of the traveling guide section 111 is the front surface side. An opposite surface of the chain traveling surface side is the rear surface side.

With the chain guide 100 according to this embodiment configured as explained above, the guide shoe 110 made of low-friction synthetic resin is formed of the bar made of the metal material contributing to strength, rigidity, and durability and is reinforced by the base member 120. Therefore, the chain guide 100 is reduced in size as a whole. It is possible to reduce an occupied space in an engine room in which the chain guide 100 is fixed.

Since the base member 120 is formed of the bar, it is possible to easily manufacture the base member 120 with a simple method of, for example, cutting a long bar at appropriate length. Further, a waste of the material, which occurs in punching or the like of a tabular material, does not occur. Therefore, it is possible to reduce manufacturing costs.

When the guide shoe 110 is formed by injection molding or the like, it is possible to insert the base member 120 into and integrate the base member 120 with the guide shoe 110. Therefore, manufacturing of the entire chain guide 100 is facilitated and manufacturing costs are reduced.

Further, on the surface in the longitudinal direction of the base member 120, a burr or the like due to cutting, punching, or the like is absent. The surface of the base member 120 can be formed as a smoother surface by forming the base member 120 as a steel bar subjected to pultrusion molding. Therefore, the guide shoe 110 is not scratched by the burr or the like. It is possible to prevent occurrence of a crack and breakage caused by scratches during use.

Note that the guide shoe 110 may be formed in a shape in which a long hole for inserting the base member 120 is provided in the chain traveling direction. The base member 120 may be inserted from the back and integrated with the guide shoe 110.

The sectional shape, the sectional area, and the like of the base member 120 can be arbitrarily set. A plurality of the base members 120 may be present in parallel to the longitudinal direction.

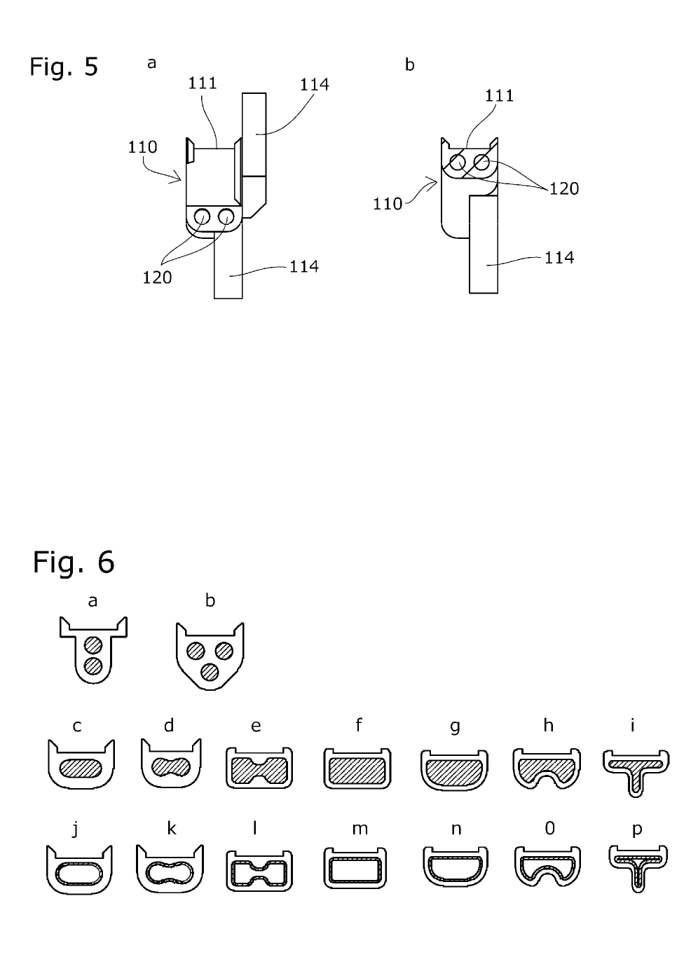

For example, as shown in FIGS. 5A and 5B, by providing two base members 120 in the width direction, it is possible to reduce a downward thickness dimension (in the up down direction in the figure) of a chain traveling surface of the guide shoe 110 and reduce the guide shoe 110 in size while securing the strength, the rigidity, the durability, and the like of the entire chain guide 100.

As shown in FIG. 6A, the two base members 120 may be provided in the thickness direction (the up down direction in the figure). As shown in FIG. 6B, three base members 120 may be provided in parallel. The number and the arrangement of the base members 120 can be arbitrarily designed.

The sectional shape of the base member 120 may be a solid arbitrary external shape as shown in, for example, FIGS. 6C to 6I according to the strength, the rigidity, the durability, and an allowed shape and an allowed dimension of the entire chain guide 100. For example, as shown in FIGS. 6J to 6P, the sectional shape of the base member 120 may be a hollow pipe-like arbitrary external shape (note that forms shown in FIGS. 6a to 6P are schematic diagrams and are examples; the sectional shapes and the sectional areas of the guide shoe 110 and the base member 120 and the number, the arrangement, and the like of the base members 120 are not limited to these forms).

The sectional shape of the base member 120 is also applicable to chain guides in a second embodiment and a third embodiment explained below.

### Second Embodiment

A chain guide 200 (a fixed guide) according to a second embodiment of the present invention is explained based on the drawings.

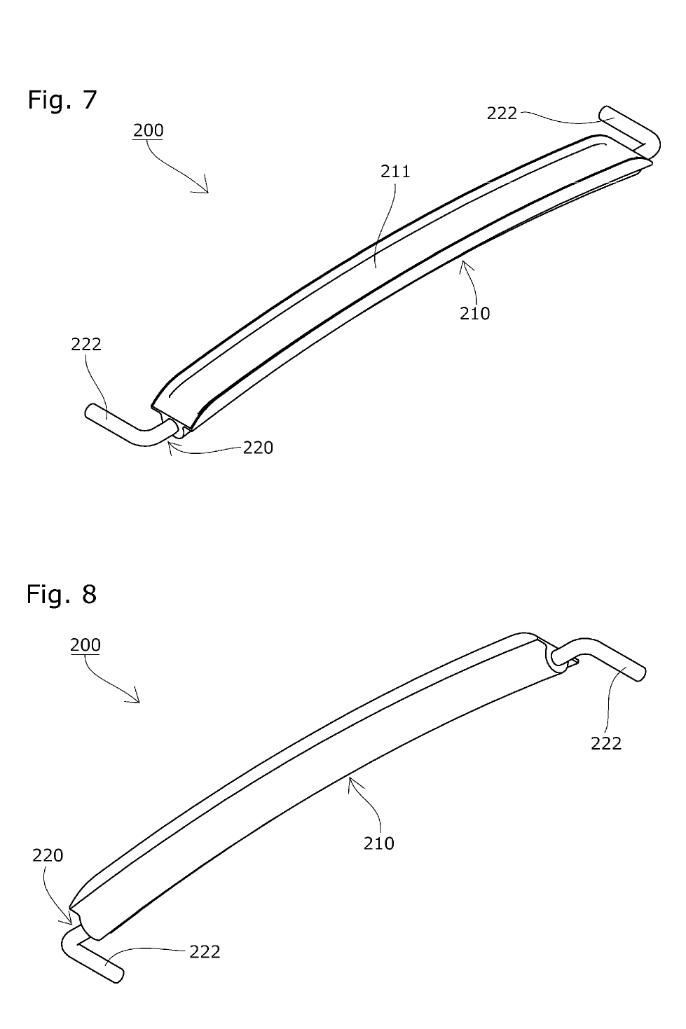

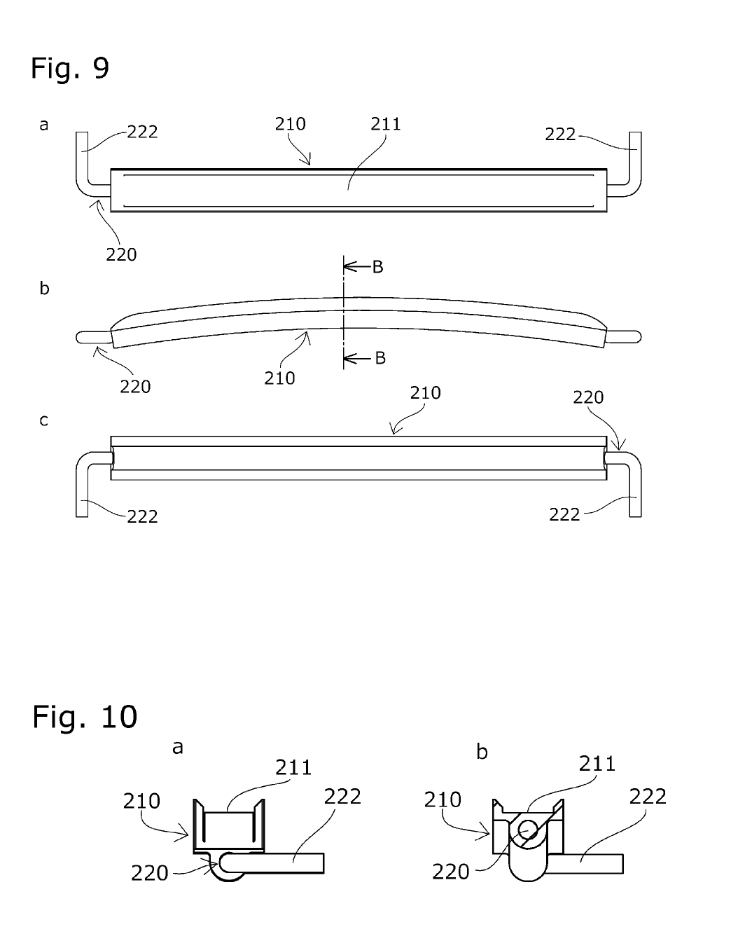

The chain guide 200 is applied to the publicly-known timing system explained above. As shown in FIG. 7 to FIGS. 10A and 10B, the chain guide 200 includes a guide shoe 210 configured to slide and guide a traveling chain and a base member 220 configured to reinforce the guide shoe 210 along a chain traveling direction and improve strength, rigidity, and durability.

The guide shoe 210 includes a traveling guide section 211 extending in the chain traveling direction. The guide shoe 210 is formed of a synthetic resin material and integrally molded by, for example, injection molding in a state in which an intermediate portion of the base member 220 is inserted into the guide shoe 210.

The base member 220 is formed of a bar of metal extending in the chain traveling direction. The base member 220 is formed by, for example, drawing a steel material and cutting the steel material at appropriate length.

Both ends of the base member 220 projecting from the guide shoe 210 are bent to be fixed in an engine room and form attaching sections 222.

In this embodiment, the attaching sections 222 are configured to be inserted into and fixed in attachment holes provided in the engine room or the like by appropriate means.

The intermediate portion of the base member 220 inserted into the guide shoe 210 is given a predetermined bending shape along the chain traveling direction.

With the chain guide 200 according to this embodiment configured as explained above, as in the first embodiment, the guide shoe 210 made of low-friction synthetic resin is formed of the bar made of the metal material contributing to strength, rigidity, and durability and is reinforced by the base member 220. Therefore, the chain guide 200 is reduced in size as a whole. It is possible to reduce an occupied space in an engine room in which the chain guide 200 is fixed.

Since the base member 220 is formed of the bar, it is possible to easily manufacture the base member 220 with a simple method of, for example, cutting a long bar at appropriate length. Further, a waste of the material, which occurs in punching or the like of a tabular material, does not occur. Therefore, it is possible to reduce manufacturing costs.

When the guide shoe 210 is formed by injection molding or the like, it is possible to insert the base member 220 into and integrate the base member 220 with the guide shoe 210. Therefore, manufacturing of the entire chain guide 200 is facilitated and manufacturing costs are reduced.

Further, on the surface in the longitudinal direction of the base member 220, a burr or the like due to cutting, punching, or the like is absent. The surface of the base member 220 can be formed as a smoother surface by forming the base member 220 as a steel bar subjected to pultrusion molding. Therefore, the guide shoe 210 is not scratched by the burr or the like. It is possible to prevent occurrence of a crack and breakage caused by scratches during use.

Note that the guide shoe 210 may be formed in a shape in which a long hole for inserting the base member 220 is provided in the chain traveling direction. The base member 220 may be inserted from the back and integrated with the guide shoe 210. Thereafter, both ends of the base member 220 may be bent.

The sectional shape, the sectional area, and the like of the base member 220 can be arbitrarily set as in the first embodiment.

The attaching sections 222 only have to be machined in an appropriate shape according to attachment places in the engine room or the like to which the chain guide 200 is attached.

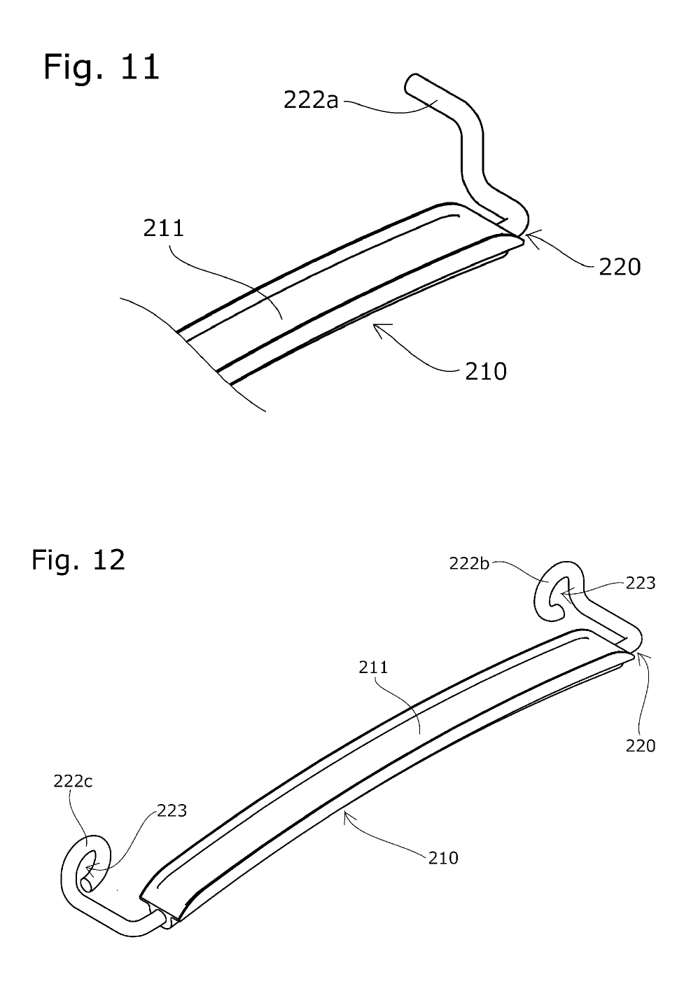

For example, as shown in FIG. 11, both the ends of the base member 220 projecting from the guide shoe 210 may be once bent upward to be higher than the chain traveling surface of the guide shoe 210. The distal ends of both ends of the base member 220 may be directed to the attachment part side in the engine room or the like and formed as attaching sections 222a.

As shown in FIG. 12, both the ends of the base member 220 projecting from the guide shoe 210 may be once bent toward the attachment part side in the engine room or the like and the distal ends may be bent in an arcuate shape parallel to an attachment surface (not shown in the figure) to form attaching sections 222b and 222c to configure attachment holes 223 for bolts or the like.

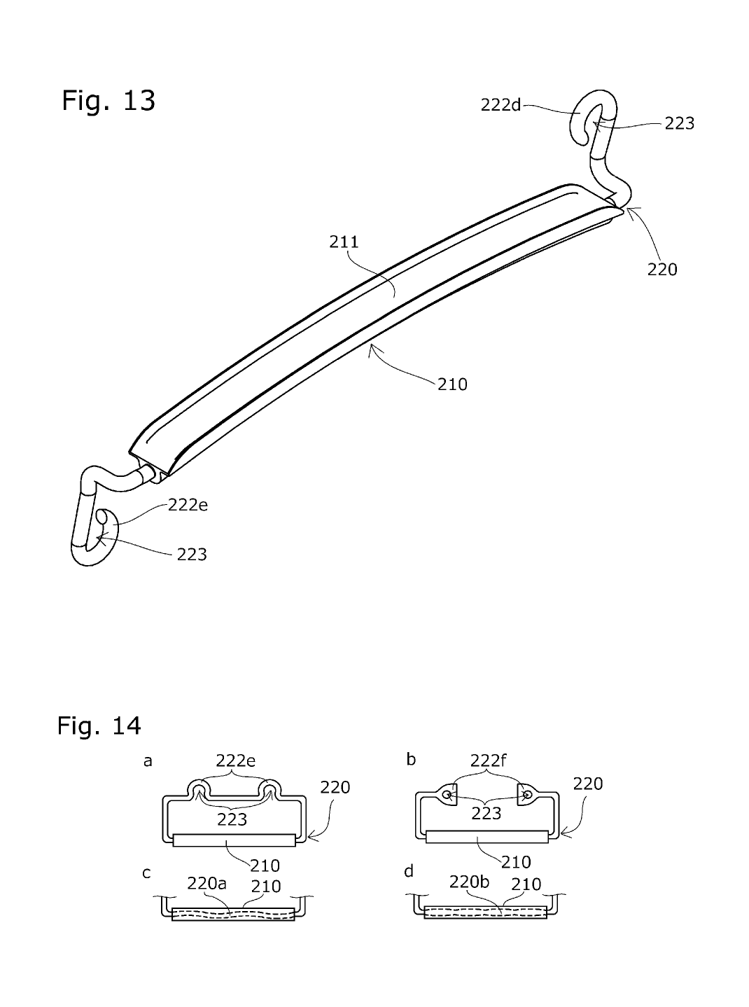

As shown in FIG. 13, both the ends of the base member 220 projecting from the guide shoe 210 may be once bent toward the attachment part side in the engine room or the like, the distal ends of both the ends may be bent in the thickness direction (the up down direction in the figure) of the guide shoe 210, and the distal ends may be further bent in an arcuate shape to form attaching sections 222d and 222e to configure the attachment holes 223 for bolts or the like.

As shown in FIG. 14A, the shape of the attaching sections of the base member 220 may be formed such that both the ends of the base member 220 projecting from the guide shoe 210 are turned around and connected. Attaching sections 222e configuring the attachment holes 223 for bolts or the like may be formed halfway in the connected both ends.

As shown in FIG. 14B, attaching sections 222f may be formed by machining the distal ends of the base member 220 projecting from the guide shoe 210 to be flat and perforating the attachment holes 223.

As the shape of both the ends of the base member 220 including the attaching sections projecting from the guide shoe 210, the forms explained above may be variously combined. Other configurations not explained as examples may be adopted.

The shape of the attaching sections 222 of the base member 220 is also applicable to a chain guide in a fourth embodiment explained below.

Further, the intermediate portion of the base member 220 inserted into the guide shoe 210 may be formed in a meandering shape as in a base member 220a shown in FIG. 14C or may be formed such that the sectional area thereof continuously changes as in a base member 220b shown in FIG. 14D. By forming the intermediate portion of the base member 220 in this way, it is possible to surely prevent the base member 220 and the guide shoe 210 from relatively moving.

The shape of the intermediate portion of the base member 220 inserted into the guide shoe 210 is also applicable to the chain guide in the first embodiment and a chain guide in a third embodiment explained below.

### Third Embodiment

A chain guide 300 (a swinging guide) according to a third embodiment of the present invention is explained based on the drawings.

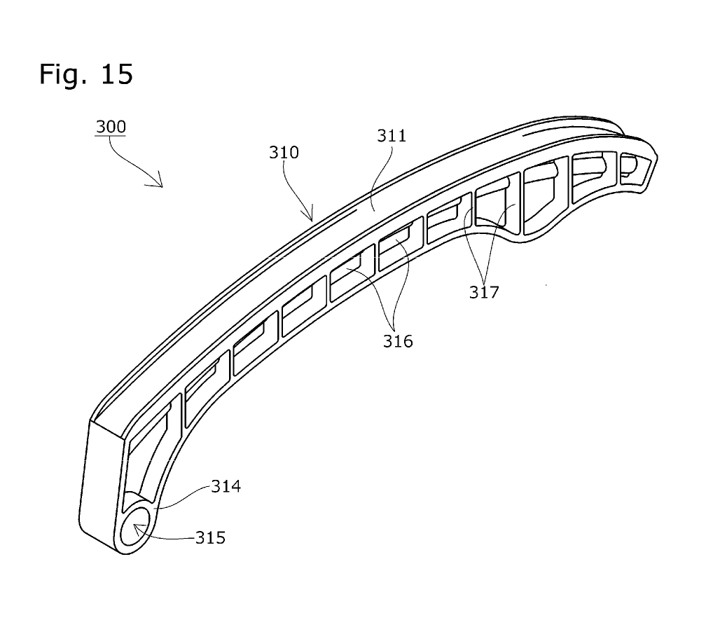

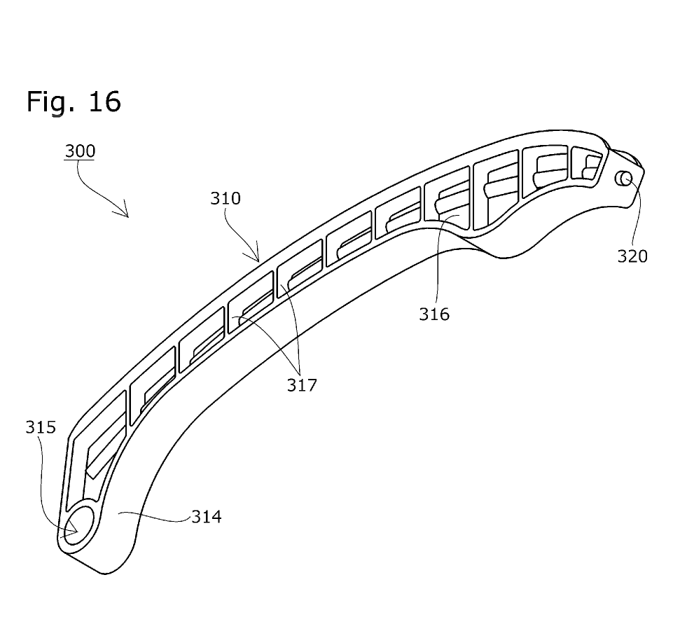

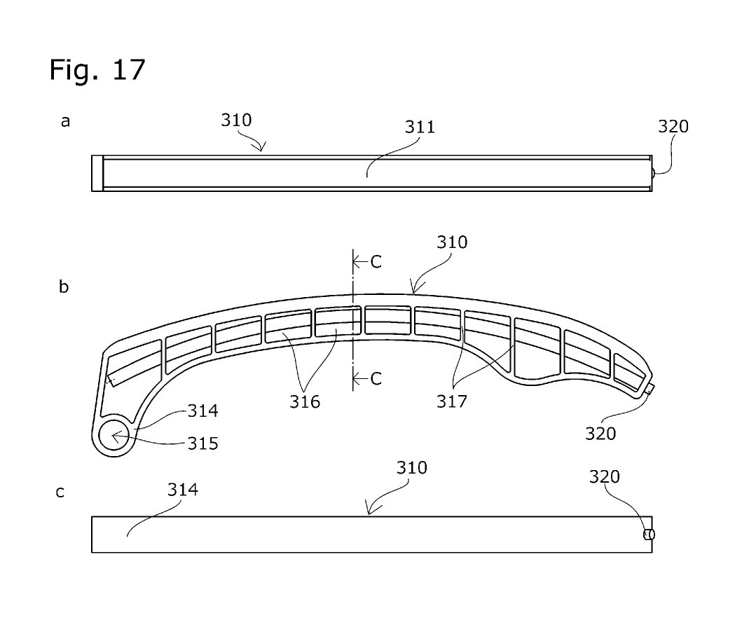

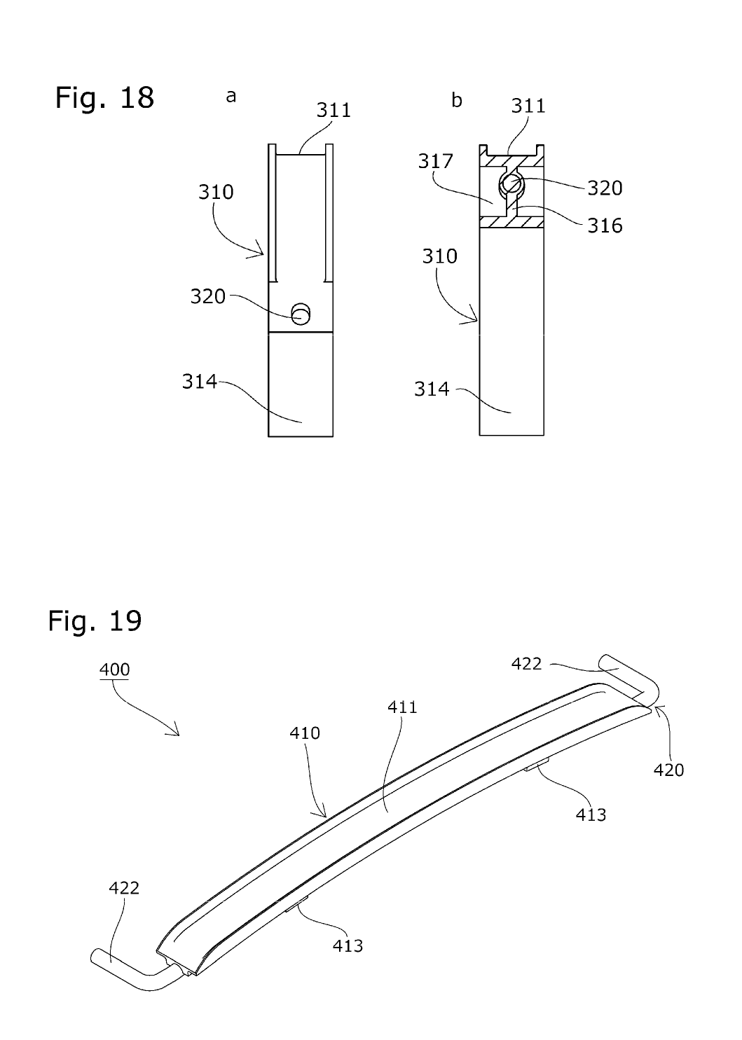

The chain guide 300 is applied to the publicly-known timing system explained above. As shown in FIG. 15 to FIGS. 18A and 18B, the chain guide 300 includes a guide shoe 310 configured to swing around an attachment hole 315 and slide and guide a traveling chain and a base member 320 configured to reinforce the guide shoe 310 along a chain traveling direction and improve strength, rigidity, and durability.

The base member 320 is formed of a bar of metal extending in the chain traveling direction. The base member 320 is formed by, for example, drawing a steel material and cutting the steel material at appropriate length.

The base member 320 is given a predetermined bending shape along the chain traveling direction.

The guide shoe 310 is formed of a synthetic resin material. The guide shoe 310 includes a traveling guide section 311 extending in the chain traveling direction and includes a vertical wall section 316 on the opposite side of chain traveling of the traveling guide section 311 and reinforcing ribs 317 for securing rigidity against bending, torsion, and the like. The guide shoe 310 is integrally molded by, for example, injection molding in a state in which the base member 320 is inserted into the guide shoe 310.

An attaching section 314 is formed to extend to the rear surface side on the upstream side in the chain traveling direction. The attachment hole 315, through which a swinging shaft or the like for swingably attaching the chain guide 300 in an engine room, is provided.

With the chain guide 300 according to this embodiment configured as explained above, as in the other embodiments, the guide shoe 310 made of low-friction synthetic resin is formed by a bar made of a metal material contributing to strength, rigidity, and durability and is reinforced by the base member 320. Therefore, the chain guide 300 is reduced in size as a whole. It is possible to reduce an occupied space in the engine room.

Since the base member 320 is formed of the bar, it is possible to easily manufacture the base member 320 with a simple method of, for example, cutting a long bar at appropriate length. Further, a waste of the material, which occurs in punching or the like of a tabular material, does not occur. Therefore, it is possible to reduce manufacturing costs.

When the guide shoe 310 is formed by injection molding or the like, it is possible to insert the base member 320 into and integrate the base member 320 with the guide shoe 310. Therefore, manufacturing of the entire chain guide 300 is facilitated and manufacturing costs are reduced.

Further, on the surface in the longitudinal direction of the base member 320, a burr or the like due to cutting, punching, or the like is absent. The surface of the base member 320 can be formed as a smoother surface by forming the base member 320 as a steel bar subjected to pultrusion molding. Therefore, the guide shoe 310 is not scratched by the burr or the like. It is possible to prevent occurrence of a crack and breakage caused by scratches during use.

Note that the guide shoe 310 may be formed in a shape in which a long hole for inserting the base member 320 is provided in the chain traveling direction. The base member 320 may be inserted from the back and integrated with the guide shoe 310.

### Fourth Embodiment

A chain guide 400 (a fixed guide) according to a fourth embodiment of the present invention is explained based on the drawings.

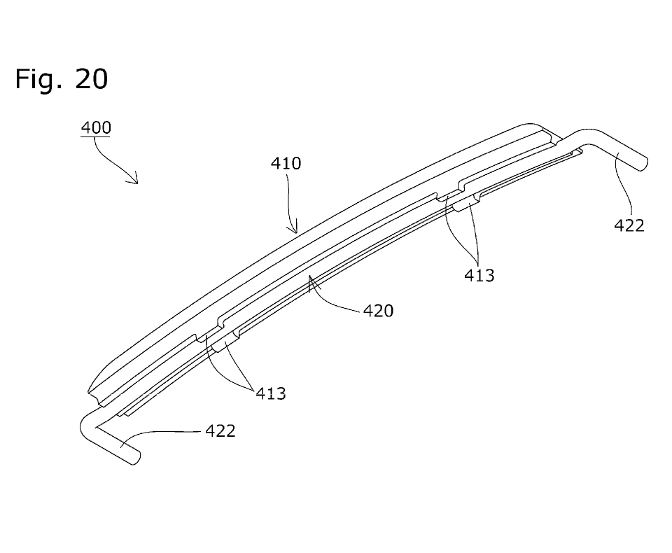

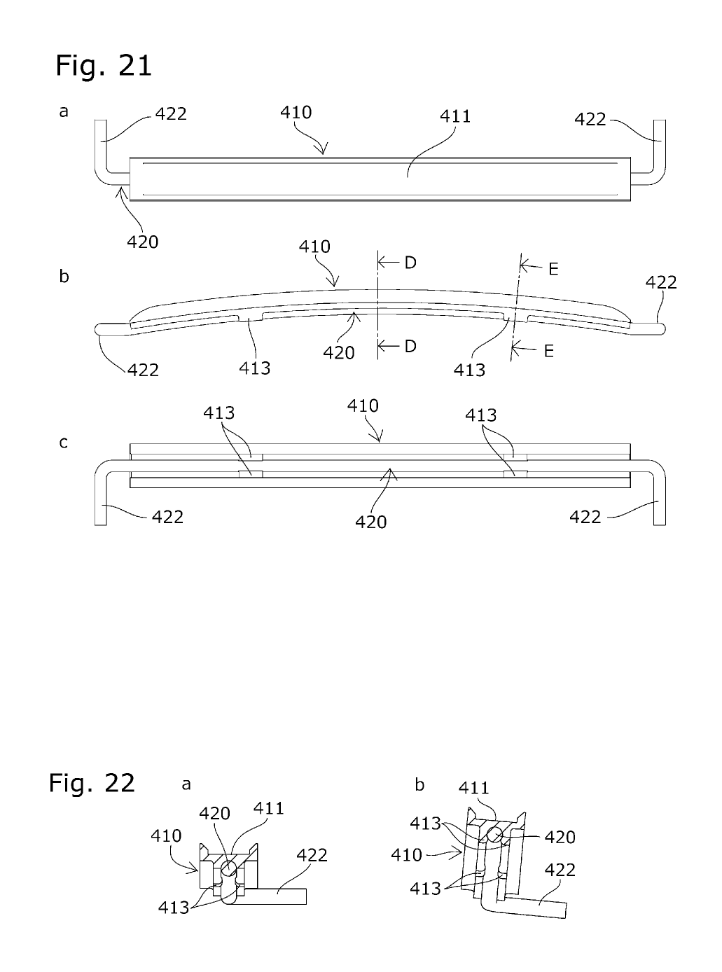

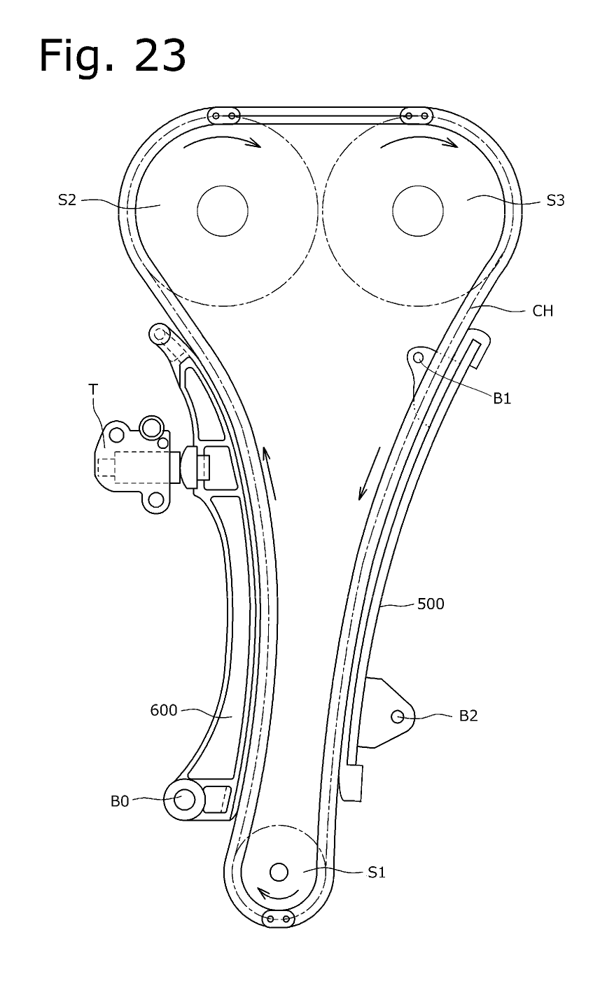

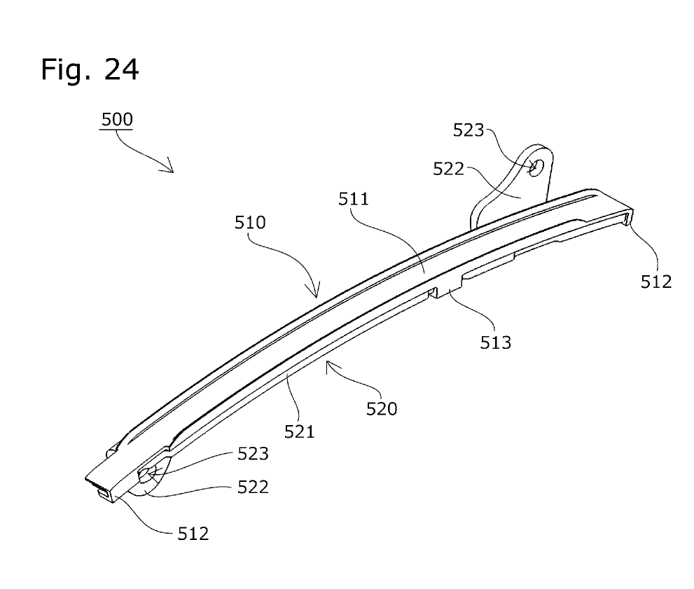

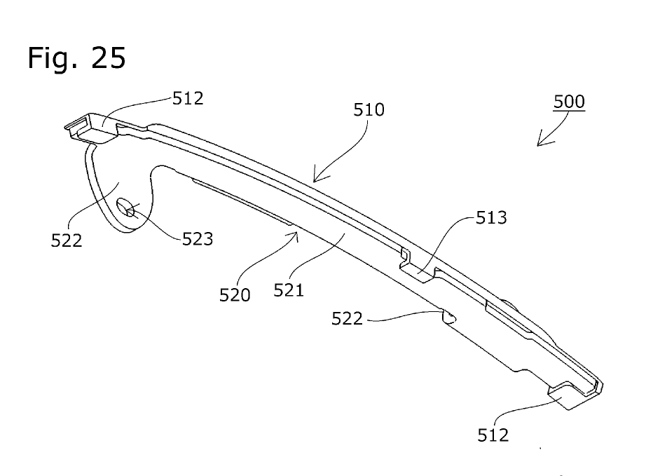

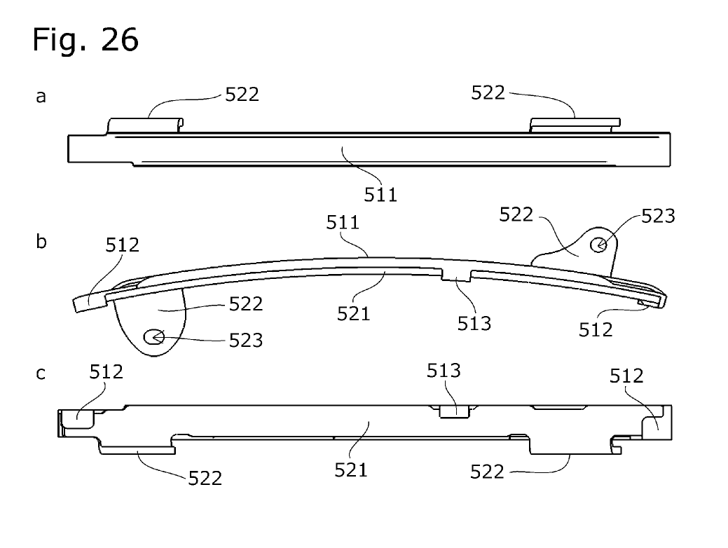

The chain guide 400 is applied to the publicly-known timing system explained above. As shown in FIG. 19 to FIGS. 22A and 22B, the chain guide 400 includes a guide shoe 410 configured to slide and guide a traveling chain and a base member 420 configured to reinforce the guide shoe 410 along a chain traveling direction and improve strength, rigidity, and durability.

The guide shoe 410 includes a traveling guide section 411 extending in the chain traveling direction. The guide shoe 410 is formed of a synthetic resin material and molded to be capable of locking, with side locking pieces 413 provided on the lower surface side of the guide shoe 410, an intermediate portion of the base member 420 and integrating the intermediate portion.

As in the second embodiment, the base member 420 is formed of a bar of metal extending in the chain traveling direction. The base member 420 is formed by, for example, drawing a steel material and cutting the steel material at appropriate length.

Both ends of the base member 420 projecting from the guide shoe 410 form attaching sections 422 bent to be fixed in an engine room.

In this embodiment, the attaching sections 422 are configured to be inserted into and fixed in attachment holes provided in the engine room or the like by appropriate means.

The intermediate portion of the base member 420 locked to the guide shoe 410 is given a predetermined bending shape along the chain traveling direction.

Note that, in order to surely prevent relative movements of the guide shoe 410 and the base member 420, at least a portion of the base member 420 may be machined in a sectional shape different from the sectional shape of the other portions and a locking section that recess-projection fits in the rear surface of the guide shoe 410, which is in contact with the portion, or the side locking pieces 413.

The intermediate portion of the base member 420 in contact with the guide shoe 410 may be formed in a shape same as the shape of the base members 220a and 220b shown in FIGS. 14C and 14D showing the modification of the second embodiment.

With the chain guide 400 according to this embodiment configured as explained above, as in the other embodiments, the guide shoe 410 made of low-friction synthetic resin is formed by a bar made of a metal material contributing to strength, rigidity, and durability and is reinforced by the base member 420. Therefore, the chain guide 400 is reduced in size as a whole. It is possible to reduce an occupied space in the engine room in which the chain guide 400 is fixed.

Since the base member 420 is formed of the bar, it is possible to easily manufacture the base member 420 with a simple method of, for example, cutting a long bar at appropriate length. Further, a waste of the material, which occurs in punching or the like of a tabular material, does not occur. Therefore, it is possible to reduce manufacturing costs.

It is possible to fit the base member 420 integrally in the guide shoe 410 from the rear surface side. Manufacturing of the entire chain guide 400 is facilitated and manufacturing costs are reduced. Further, even when the base member 420, a form of the attaching sections 422 of which is different according to design of the engine room in which the chain guide 400 is fixed, is used, it is possible to use the same guide shoe 410. As a result, versatility is improved.

Further, on the surface in the longitudinal direction of the base member 420, a burr or the like due to cutting, punching, or the like is absent. The surface of the base member 420 can be formed as a smoother surface by forming the base member 420 as a steel bar subjected to pultrusion molding. Therefore, the guide shoe 410 is not scratched by the burr or the like. It is possible to prevent occurrence of a crack and breakage caused by scratches during use.

Note that the sectional shape, the sectional area, and the like of the base member 420 can be arbitrarily set as in the other embodiments.

The attaching sections 422 only have to be machined in an appropriate shape according to attachment places in the engine room or the like to which the chain guide 200 is attached as in the second embodiment.

The embodiments explained above are specific examples of the chain guide according to the present invention. However, the chain guide according to the present invention is not limited to the embodiments. Various modifications are possible concerning the shapes, the positions, the dimensions, the arrangement relation, and the like of the components. The shapes of the components in the embodiments may be combined as appropriate.

For example, the structure for integration of the base member by the side locking pieces in the fourth embodiment may be adopted for the guide shoe 110 in the first embodiment. A structure may be adopted in which, at one end in the longitudinal direction of a chain guide, an attaching section is provided in a guide shoe as in the first embodiment and, at the other end, an attaching section is provided in a base member as in the second embodiment and the fourth embodiment.

In the embodiments, the chain guide is provided in the engine including the timing system. However, the chain guide is not limited to this and can be applied to various machines.

The chain guide is not limited to the driving mechanism by the chain and may be applied to similar driving mechanisms such as a belt and a rope. The chain guide can be used in various industrial fields.

What is claimed is:

1. A chain guide comprising:
a guide shoe configured to slide and guide a traveling chain;
a base member configured to reinforce the guide shoe along a chain traveling direction; and
at least one attaching section,
the base member being formed by a bar made of a metal material.

2. The chain guide according to claim 1, wherein
the guide shoe is formed of a synthetic resin material, and
the base member is formed of a steel bar subjected to pultrusion molding.

3. The chain guide according to claim 1, wherein the at least one attaching section is formed by bending the base member.

4. The chain guide according to claim 1, wherein the at least one attaching section is formed integrally with the guide shoe.

5. The chain guide according to claim 1, wherein
two or more attaching sections are provided,
at least one of the attaching sections is formed by bending the base member, and
at least another one of the attaching sections is formed integrally with the guide shoe.

6. The chain guide according to claim 1, wherein the base member is integrated with the guide shoe during manufacturing of the guide shoe.

7. The chain guide according to claim 1, wherein the base member is configured to be attachable to and detachable from the guide shoe.

8. The chain guide according to claim 1, wherein the base member is formed in a pipe shape including a hollow inside thereof.

9. The chain guide according to claim 1, wherein a plurality of base members are provided in parallel.

10. The chain guide according to claim 1, wherein at least a portion of the base member is machined into a sectional shape which differs from a sectional shape of other portions.
